(19) United States
(12) Patent Application Publication
(10) Pub. No.: US 2021/0295033 A1
(43) Pub. Date: Sep. 23, 2021

(54) INFORMATION PROCESSING APPARATUS AND NON-TRANSITORY COMPUTER READABLE MEDIUM

(71) Applicant: FUJIFILM Business Innovation Corp., Tokyo (JP)

(72) Inventor: Naoya TAKAYAMA, Kanagawa (JP)

(73) Assignee: FUJIFILM Business Innovation Corp., Tokyo (JP)

(21) Appl. No.: 16/986,244

(22) Filed: Aug. 5, 2020

(30) Foreign Application Priority Data
Mar. 18, 2020 (JP) 2020-048019

(51) Int. Cl. G06K 9/00; G06F 16/93; G06F 16/9032

(52) U.S. Cl. CPC G06K 9/00463; G06F 16/93; G06K 2209/01; G06F 16/90332; G06K 9/00469

(57) ABSTRACT

An information processing apparatus includes a processor configured to: perform a document search by using data stored in a memory, the data including attribute information indicating attributes appended to each document. The attributes includes a user-appended attribute and a software-extracted attribute extracted by document management software. The user-appended attribute and the software-extracted attribute are configured to be distinguishable from each other.

### CROSS-REFERENCE TO RELATED APPLICATIONS

This application is based on and claims priority under 35 USC 119 from Japanese Patent Application No. 2020-048019 filed Mar. 18, 2020.

### BACKGROUND

### (i) Technical Field

The present disclosure relates to an information processing apparatus and a non-transitory computer readable medium.

### (ii) Related Art

Japanese Unexamined Patent Application Publication No. 2004-171316 proposes a method for searching for a set of documents including a given keyword by using a character recognition technology, as a document searcher for paper documents and document images, and discloses the following system. A character recognition unit and a search unit are separately provided. Extracted character string candidates, character candidates separated from character strings, and character recognition results are formed as a hypothesis file. Based on this file, a function of searching for keywords is formed. With the use of this system, it is possible to search for a necessary document and to perform document sorting.

Japanese Unexamined Patent Application Publication No. 7-160730 discloses the following full-text search unit that can reliably conduct a search even in a wrongly recognized document. The full-text search unit includes a conversion candidate creator, a file, a keyword converter, and a searcher. When it is difficult to convert a printed document from image data into text data, the conversion candidate creator creates multiple conversion candidates by using a standard pattern, for example, and sets a first candidate to fixed document data and second and subsequent candidates to conversion candidate data. The file stores the created fixed document data and conversion candidate data. The keyword converter creates a similar keyword by replacing a character of an input keyword with a character indicated by the conversion candidate data stored in the file, and generates a search formula including the input keyword and the similar keyword. The searcher searches the fixed document data stored in the file, based on the search formula.

Japanese Patent No. 3689455 discloses the following information processing method for use in an information processing apparatus including a character recognizer, a storage, and a selector for selecting a character string. In the information processing method, text information recognized by the character recognizer from a document image is searched for a character string selected by the selector. The information processing method includes a determining step, a generating step, a detecting step, a judging step, and a displaying step. In the determining step, a determinator of the information processing apparatus refers to the storage in which a specific character is stored and determines whether the specific character is contained in the selected character string. In the generating step, if it is determined in the determining step that the specific character is contained, a generator of the information processing apparatus generates partial character strings, each of which is constituted by continuous characters in the selected character string and does not contain the specific character. In the detecting step, a detector of the information processing apparatus detects whether an index having the same number of characters as the partial character strings, which is generated from the text information, includes all the partial character strings. In the judging step, if it is detected in the detecting step that all the partial character strings are included in the index, a judger of the information processing apparatus judges whether a character string pattern in which the specific character in the selected character string is replaced with another character string having a predetermined number of characters or fewer is included in the text information. In the displaying step, a displaying unit of the information processing apparatus displays on a display the text information which is found to include the character string pattern in the judging step or a corresponding document image as a search result.

### SUMMARY

When a search is conducted by using attribute information appended to a document, a search is unconditionally conducted regardless of whether the attribute information is information that can be appended by a user or whether the attribute information is automatically extracted by document management software. This causes omission of words or noise words in the search results.

Aspects of non-limiting embodiments of the present disclosure relate to an information processing apparatus and a non-transitory computer readable medium that are less likely to cause omission of words or noise words in the results of a search conducted by using attribute information, compared with a case in which a search is conducted unconditionally by using attribute information regardless of whether the attribute information is information that can be appended by a user or whether attribute information is automatically extracted by document management software.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to: perform a document search by using data stored in a memory, the data including attribute information indicating attributes appended to each document. The attributes includes a user-appended attribute and a software-extracted attribute extracted by document management software. The user-appended attribute and the software-extracted attribute are configured to be distinguishable from each other.

### BRIEF DESCRIPTION OF THE DRAWINGS

An exemplary embodiment of the present disclosure will be described in detail based on the following figures, wherein:

FIG. 1 is a block diagram illustrating conceptual modules forming an example of the configuration of the exemplary embodiment;

FIGS. 2A and 2B are schematic diagrams illustrating examples of the system configuration utilizing the exemplary embodiment;

FIG. 3 illustrates an example of processing in the exemplary embodiment;

FIG. 4 is a block diagram illustrating specific modules forming an example of the configuration of the exemplary embodiment;

FIG. 5 is a flowchart illustrating an example of processing in the exemplary embodiment;

FIG. 6A illustrates a display example of an environment setting (attribute A extraction rules) screen; and

FIGS. 6B and 6C illustrate display examples of an editing screen;

FIG. 7 illustrates a display example of an environment setting (attribute B extraction rules) screen;

FIG. 8 is a flowchart illustrating an example of processing in the exemplary embodiment;

FIG. 9 illustrates an example of processing in the exemplary embodiment;

FIG. 10 illustrates a display example of an attribute B display region;

FIG. 11 illustrates a display example of an attribute search screen;

FIG. 12 illustrates a display example of a search result screen; and

FIG. 13 illustrates an example of the data structure of a key/value extracting table.

### DETAILED DESCRIPTION

An exemplary embodiment of the disclosure will be described below with reference to the accompanying drawings.

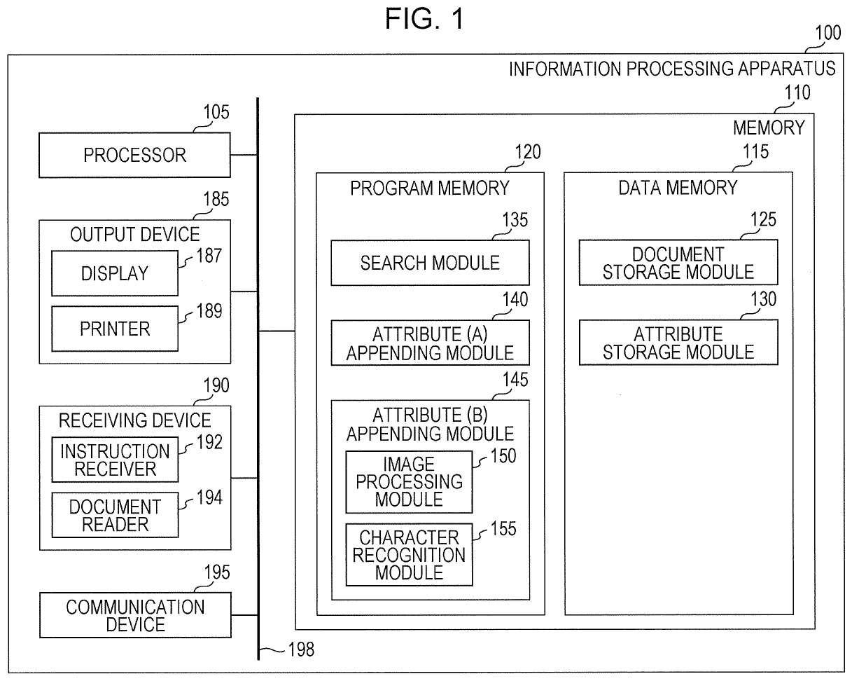

FIG. 1 is a block diagram illustrating conceptual modules forming an example of the configuration of the exemplary embodiment.

Generally, modules are software (computer programs) components or hardware components that can be logically separated from one another. The modules of the exemplary embodiment of the disclosure are, not only modules of a computer program, but also modules of a hardware configuration. Thus, the exemplary embodiment will also be described in the form of a computer program for allowing a computer to function as those modules (a program for causing a computer to execute program steps, a program for allowing a computer to function as corresponding units, or a computer program for allowing a computer to implement corresponding functions), a system, and a method. While expressions such as “store”, “storing”, “being stored”, and equivalents thereof are used for the sake of description, such expressions indicate, when the exemplary embodiment relates to a computer program, storing the computer program in a storage device or performing control so that the computer program will be stored in a storage device. Modules may correspond to functions based on a one-to-one relationship. In terms of implementation, however, one module may be constituted by one program, or plural modules may be constituted by one program. Conversely, one module may be constituted by plural programs. Additionally, plural modules may be executed by using a single computer, or one module may be executed by using plural computers in a distributed or parallel environment. One module may integrate another module therein. Hereinafter, the term “connection” includes not only physical connection, but also logical connection (sending and receiving of data, giving instructions, reference relationships among data elements, login, etc.). The term “predetermined” means being determined prior to a certain operation, and includes the meaning of being determined prior to a certain operation before starting processing of the exemplary embodiment, and also includes the meaning of being determined prior to a certain operation even after starting processing of the exemplary embodiment, in accordance with the current situation/state or in accordance with the previous situation/state. If there are plural “predetermined values”, they may be different values, or two or more of the values (or all the values) may be the same. A description having the meaning “in the case of A, B is performed” is used as the meaning “it is determined whether the case A is satisfied, and B is performed if it is determined that the case A is satisfied”, unless such a determination is unnecessary. If elements are enumerated, such as “A, B, and C”, they are only examples unless otherwise stated, and such enumeration includes the meaning that only one of them (only the element A, for example) is selected.

A system or an apparatus (or a device) may be implemented by connecting plural computers, hardware units, devices, etc., to one another via a communication medium, such as a network (including communication connection based on a one-to-one correspondence), or may be implemented by a single computer, hardware unit, device, etc. The terms “apparatus” and “system” are used synonymously. The term “system” does not include a mere man-made social “mechanism” (social system).

Additionally, every time an operation is performed by using a corresponding module or every time each of plural operations is performed by using a corresponding module, target information is read from a storage device, and after performing the operation, a processing result is written into the storage device. A description of reading from the storage device before an operation or writing into the storage device after an operation may be omitted.

An information processing apparatus 100 according to the exemplary embodiment has a search function of conducting a search by using attribute information appended to a document. As shown in FIG. 1, the information processing apparatus 100 at least includes a processor 105 and a memory 110. A bus 198 connects the processor 105 and the memory 110 so that they can exchange data therebetween. The information processing apparatus 100 may also include an output device 185, a receiving device 190, and a communication device 195. Data is exchanged between the processor 105, the memory 110, the output device 185, the receiving device 190, and the communication device 195 via the bus 198.

FIG. 1 also illustrates an example of the hardware configuration of a computer implementing the exemplary embodiment. The computer on which a program serving as the exemplary embodiment is executed has the hardware configuration shown in FIG. 1, for example, and more specifically, the computer is a personal computer (PC) or a server. The computer shown in FIG. 1 includes the processor 105 as a processing unit and the memory 110 as a storage device.

As the processor 105, one or multiple processors may be used. The processor 105 may include a central processing unit (CPU) or a microprocessor, for example. If multiple processors 105 are used, they may be implemented as either one of a tightly coupled multiprocessor and a loosely coupled multiprocessor. For example, multiple processor cores may be loaded within a single processor 105. A system in which plural computers connect with each other by a communication channel so as to behave like one computer in a virtual manner may be utilized. As a specific example, multiple processors 105 may be a loosely coupled multiprocessor and be formed as a cluster system or a computer cluster. The processor 105 executes programs stored in a program memory 120.

The memory 110 may include semiconductor memory units within the processor 105, such as a register and a cache memory. The memory 110 may include a main memory device (main storage device) constituted by a random access memory (RAM) and a read only memory (ROM), for example, an internal storage device, such as a hard disk drive (HDD) and a solid state drive (SDD), having a function as a persistent storage, an external storage device and an auxiliary storage device, such as a compact disc (CD), a digital versatile disk (DVD), a Blu-ray (registered trademark) disc, a universal serial bus (USB) memory, and a memory card. The memory 110 may also include a storage, such as a server, connected to the computer via a communication network.

The memory 110 includes as major elements a program memory 120 principally storing programs and a data memory 115 principally storing data. In the program memory 120 and the data memory 115, in addition to the module programs shown in FIG. 1, programs, such as an operating system (OS) for starting the computer, and data, such as parameters that appropriately change during the execution of the module programs, may be stored.

The output device 185 includes a display 187 and a printer 189, for example. The display 187 is a liquid crystal display, an organic electroluminescence (EL) display, or a three-dimensional (3D) display, for example. The display 187 displays processing results of the processor 105 and data stored in the data memory 115 as text or image information, for example. The printer 189 is a printer or a multifunction device, which is an image processing device having at least two of the functions of a scanner, a printer, a copying machine, and a fax machine. The printer 189 prints processing results of the processor 105 and data stored in the data memory 115, for example. The output device 185 may include a speaker and an actuator for vibrating equipment.

The receiving device 190 includes an instruction receiver 192 and a document reader 194. The instruction receiver 192, such as a keyboard, a mouse, a microphone, and a camera (including a gaze detection camera), receives data based on an operation (including motion, voice, and gaze) performed on the instruction receiver 192 by a user.

A device having both the functions of the display 187 and the instruction receiver 192, such as a touchscreen, may be used. In this case, to implement the function of the keyboard, a keyboard drawn on the touchscreen by using software, that is, a software keyboard or a screen keyboard, may be used instead of a physical keyboard.

As a user interface (UI), the display 187 and the instruction receiver 192 are principally used.

The document reader 194, such as a scanner or a camera, reads a document or captures an image of the document and receives resulting image data.

The communication device 195 is a communication network interface, such as a network card, for enabling the computer to connect to another apparatus via a communication network.

In the above-described exemplary embodiment, concerning elements implemented by a software computer program, such a computer program is read into the program memory 120 having the hardware configuration shown in FIG. 1, and the exemplary embodiment is implemented by a combination of software and hardware resources.

The hardware configuration of the information processing apparatus 100 in FIG. 1 is only an example, and the exemplary embodiment may be configured in any manner if the modules described in the exemplary embodiment are executable. For example, as the processor 105, a graphics processing unit (GPU) or a general-purpose computing on graphics processing unit (GPGPU) may be used. Some modules may be configured as dedicated hardware, for example, an application specific integrated circuit (ASIC) or a field-programmable gate array (FPGA), or some modules may be installed in an external system and be connected to the information processing apparatus 100 via a communication network. A system, such as that shown in FIG. 1, may be connected to a system, such as that shown in FIG. 1, via a communication network, and may be operated in cooperation with each other. Additionally, instead of into a PC, the modules may be integrated into a mobile information communication device (including a cellular phone, a smartphone, a mobile device, and a wearable computer), a home information appliance, a robot, a copying machine, a fax machine, a scanner, a printer, and a multifunction device (an image processing device including at least two of the functions of a scanner, a printer, a copying machine, and a fax machine).

The processor 105 is connected to the memory 110, the output device 185, the receiving device 190, and the communication device 195 via the bus 198. The processor 105 executes processing in accordance with a computer program describing an execution sequence of each module, which is a program stored in the program memory 120. For example, in response to the document reader 194 reading the image of a document or the instruction receiver 192 receiving an operation from a user, the processor 105 executes processing by using the module within the program memory 120 corresponding to the content of the operation of the document reader 194 or the instruction receiver 192, and stores the processing result in the data memory 115, outputs it to the display 187, or causes the communication device 195 to send it to another apparatus.

The memory 110 includes the data memory 115 and the program memory 120 and is connected to the processor 105, the output device 185, the receiving device 190, and the communication device 195 via the bus 198.

The data memory 115 includes a document storage module 125 and an attribute storage module 130.

The document storage module 125 stores a document. A document (also called a file) is text data, numerical value data, graphics data, image data, video data, sound data, or a combination thereof. A document is a subject that can be stored, edited, and searched for and can also be exchanged between systems or users as an individual unit. The concept of documents also include their equivalents. Specific examples of documents are documents created by document management software including a document creating program, that is, word-processing software, images read by an image reader, such as a scanner, and web pages.

The attribute storage module 130 stores attribute information appended to documents. The attribute information is a subject to be searched for and is used for conducting a document search. The attribute information can be largely divided into two categories. One category is first attribute information that a user can append (user-appended attribute), and the other category is second attribute information to be extracted by document management software (software-extracted attribute). That is, the attribute storage module 130 stores attribute information appended to a document in association with information indicating whether this attribute information is the first attribute information or the second attribute information. The information indicating whether attribute information is the first attribute information or the second attribute information may be implemented as a flag indicating the first attribute information or a flag indicating the second attribute information. Alternatively, attribute information as the first attribute information and attribute information as the second attribute information are stored in different tables so that they can be distinguished from each other. The first attribute information may include plural types of information. Examples of the plural types of first attribute information are the document creation date and the document creator, which will be discussed later. The second attribute information may include plural types of information. Examples of the plural types of second attribute information are the properties of characters and the positions of the characters, which will be discussed later.

The first attribute information is attribute information that a user, such as a document creator, can append. Typically, the first attribute information is document properties and can be input by a user. However, the first attribute information may not necessarily be input by a user, and instead may be input by document management software. Even in this case, a user can still correct the first attribute information input by document management software by using an attribute display screen. That is, “a user can append the first attribute information” refers to that the user can input the value of an attribute or correct the value. Examples of the first attribute information that can be corrected by a user are the document creation date and the document creator. The document creation date is usually appended by a terminal, such as a PC, used by a user in accordance with the date on which the document is stored, while the document creator is usually appended by document management software. However, both of the items of attribute information can be corrected by a user. “User” may be a user who can edit the content of a document or attribute information appended to the document. Examples of the user are a document creator, a document corrector, a proofreader, and the boss of the document creator. “User” may be restricted to some of these examples.

The second attribute information is attribute information that can be fixed in accordance with the content of a document and that are extracted by document management software. For example, when a document is an image, character recognition processing may be executed on the document, and text, which is a result of recognizing character images in the document, may be set as the second attribute information. The result of executing image analysis or language processing on character images in a document may also be set as the second attribute information. Specific examples of the second attribute information are the properties of characters, the positions of characters, statistical information concerning character strings, parts of speech of character strings, and a character string having a predetermined positional relationship with a predetermined character string, which will be discussed later.

More specifically, in response to an instruction to append the second attribute information from a user, document management software may extract or calculate values, and such values may be set as the second attribute information. It is now assumed that the size of characters, which is an example of the properties of characters, is appended to a document as attribute information. In this case, as a result of document management software determining the size of each character within the document and extracting character strings in a size equal to or higher than a threshold, the character strings in a size equal to or higher than the threshold (specific character strings) may be automatically set as the content of attribute information “the size of characters”. The second attribute information is an attribute extracted by document management software. A user does not extract the second attribute information from a document but may correct its content, as stated above.

The first attribute information is appended with the intervention of a user and is thus regarded as reliable information. In contrast, the second attribute information is automatically appended by document management software and may not always be correct depending on the character recognition performance. The second attribute information may thus be regarded as uncertain information. Hereinafter, the first attribute information will also be called an attribute A, while the second attribute information will also be called an attribute B.

The program memory 120 stores a search module 135, an attribute (A) appending module 140, and an attribute (B) appending module 145.

The search module 135 conducts a document search by using the first attribute information and the second attribute information.

The search module 135 may conduct a search in accordance with the priority ranks set for the types of second attribute information.

When a document is an image and when the result of analyzing the image is provided as the second attribute information, the plural types of second attribute information may include at least one of the properties of characters, the positions of characters, statistical information concerning character strings, parts of speech of character strings, and a character string having a predetermined positional relationship with a predetermined character string.

In this case, the search module 135 may change the priority ranks set for the types of second attribute information and specify, among the plural types of second attribute information, a type of the second attribute information as a higher priority to be used for conducting a search.

Analyzing of an image includes recognizing characters in the image and extracting the position, size, and font of characters.

Examples of the properties of characters are the size, color, and font of characters, handwritten characters, and printed characters. The positions of characters are the positions of characters in a document, such as the header, footer, top right, bottom right, top left, and top right of the document. Examples of the statistical information concerning character strings are the number of times each character string appears in a document and term frequency-inverse document frequency (tf-idf). A character string may be a character or a set of characters that can be extracted as a word as a result of conducting morphological analysis. Examples of parts of speech are noun, verb, adjective, and adverb. The noun may be divided into person names, place names, and other types. A character string having a predetermined positional relationship with a predetermined character string is determined in the following manner. A predetermined character string and a predetermined positional relationship are stored in association with each other. If the predetermined character string is found in a character recognition result, a portion of the character recognition result corresponding to a character string having the predetermined positional relationship with this predetermined character string is extracted. For example, it is now assumed that the predetermined character string is “creator” and the predetermined positional relationship is “a character string positioned on the right side of a character string indicated as “creator”. In this case, if the character string “creator” is found in the character recognition result, the character string positioned on the right side of the character string “creator” is extracted as the name of the creator.

For the first attribute information, the search module 135 may be able to select one of an exact match search and a partial match search to be conducted. For the second attribute information, the search module 135 conducts a partial match search.

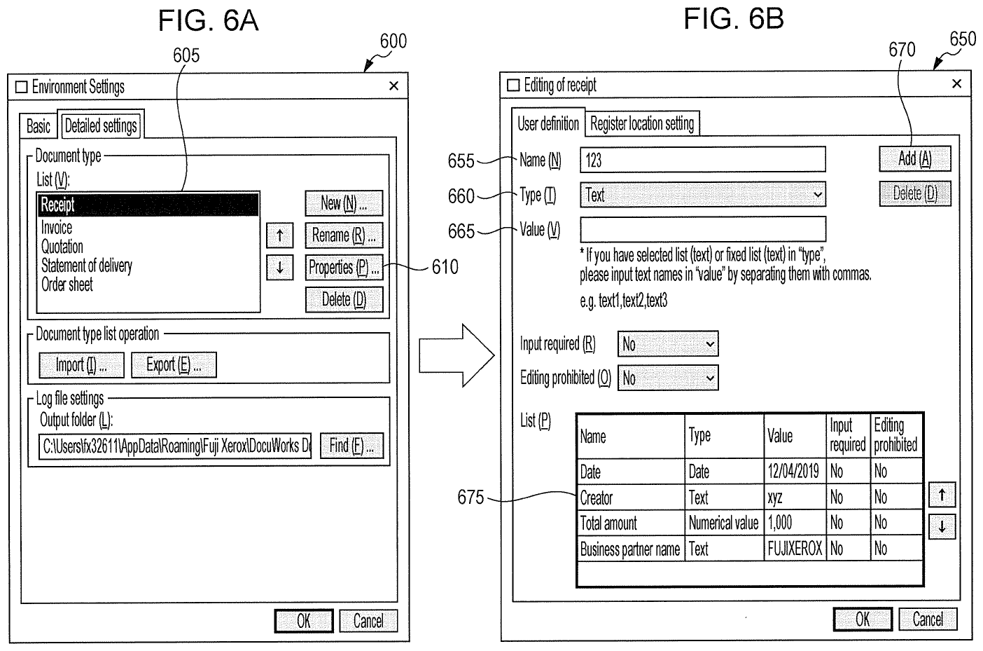

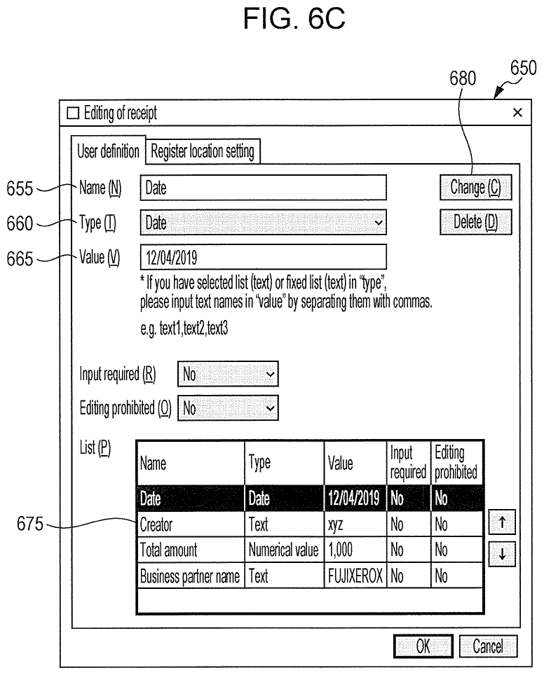

The attribute (A) appending module 140 appends the first attribute information to a document. As stated above, regarding the document creation date, a user may append it as the first attribute information, or document management software in a PC may append the date on which the document is stored as the first attribute information. The document reader 194 may alternatively append the date on which the document is read as the document creation date. Regarding the document creator, document management software may append the name of an operator operating the PC as the document creator, or the document reader 194 may append the name of a user logged in the PC as the document creator. These attributes are examples of the attributes automatically appended by document management software. As stated above, however, a user may still append such attributes or may correct the values of the attributes. An example in which a user corrects an attribute will be discussed later with reference to FIGS. 6A through 6C.

The attribute (B) appending module 145 includes an image processing module 150 and a character recognition module 155. The attribute (B) appending module 145 appends the second attribute information to a document.

The image processing module 150 analyzes the image of a document, extracts the properties of characters and the positions of the characters, and appends them to the document as the second attribute information.

The character recognition module 155 executes character recognition processing on character images within the image of a document and appends text, which is the character recognition result, to the document as the second attribute information. The attribute (B) appending module 145 may also execute language processing, such as morphological analysis, on the character recognition result. The attribute (B) appending module 145 then extracts statistical information concerning character strings, parts of speech of character strings, and a character string having a predetermined positional relationship with a predetermined character string, and appends them as the second attributes. A user does not extract these attributes from a document.

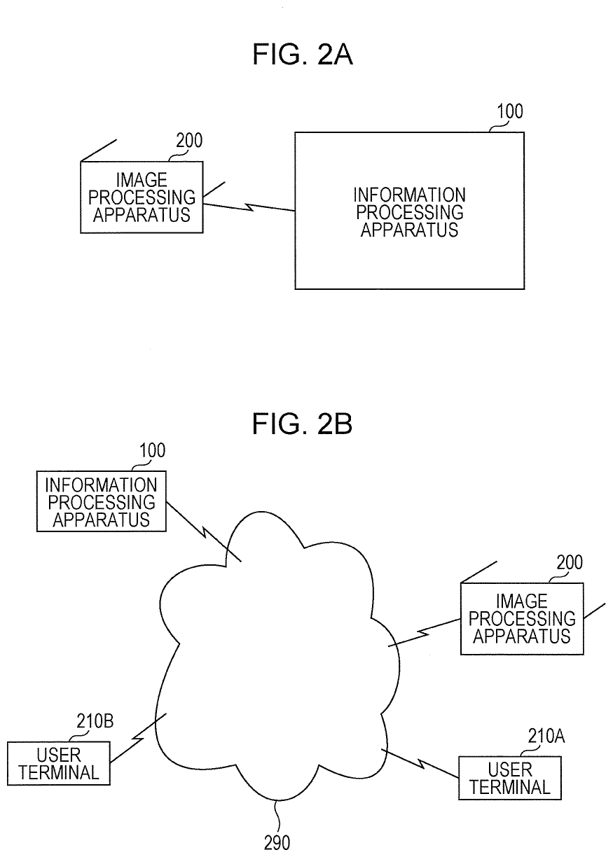

FIG. 2A illustrates an example of the system configuration of the exemplary embodiment constructed as a standalone system.

The information processing apparatus 100 and an image processing apparatus 200 are connected with each other. The image processing apparatus 200 has a scanning function and a printing function, for example. The image processing apparatus 200 is a multifunction device, for example. The information processing apparatus 100 implements the functions of the printer 189 and the document reader 194 by using the image processing apparatus 200. The information processing apparatus 100 may be integrated in the image processing apparatus 200, so that a search is conducted only with the image processing apparatus 200.

FIG. 2B illustrates an example of the system configuration of the exemplary embodiment constructed as a network system.

The information processing apparatus 100, the image processing apparatus 200, and user terminals 210A and 210B are connected with each other via a communication network 290. The communication network 290 may be a wireless or wired medium, or a combination thereof, and may be, for example, the Internet or an intranet as a communication infrastructure. The functions of the information processing apparatus 100 may be implemented as cloud services.

Whichever mode of the configuration in FIG. 2A or 2B is employed, a user reads a paper document by using the scanner function of the image processing apparatus 200 and stores the read image of the document in the information processing apparatus 100, for example. In this case, the first attribute information and the second attribute information are appended to the document. The user then conducts a search for a document stored in the information processing apparatus 100 by using the user terminal 210. For example, the user connects to the information processing apparatus 100 by using a browser of the user terminal 210, and conducts a document search by using the function of the information processing apparatus 100.

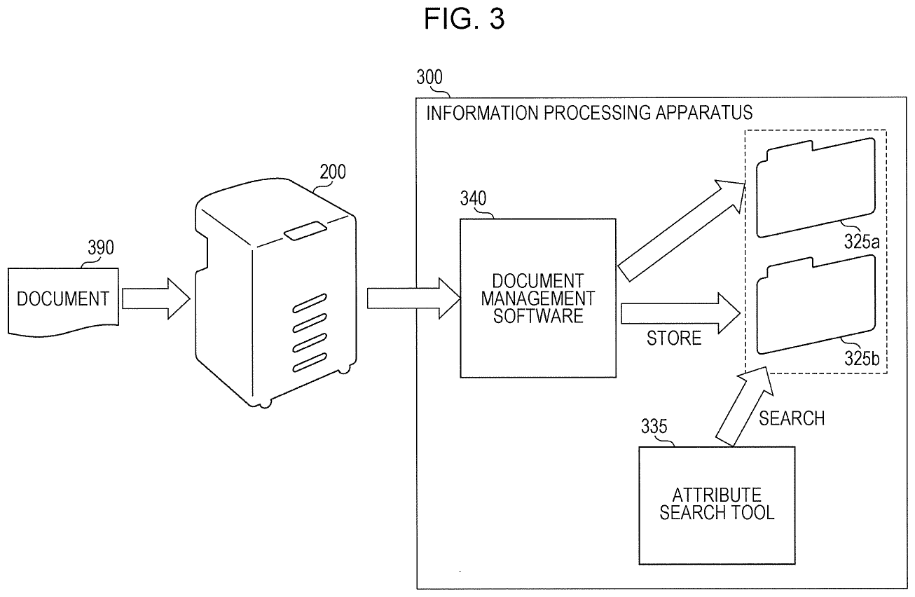

FIG. 3 illustrates an example of processing in the exemplary embodiment. The module configuration in an information processing apparatus 300 will be explained below in comparison with that shown in FIG. 1.

The information processing apparatus 300 includes an attribute search tool 335, document management software 340, and folders 325a and 325b.

The image processing apparatus 200 is connected to the document management software 340 in the information processing apparatus 300. The image processing apparatus 200 reads a document 390 and sends the image of the document 390 to the information processing apparatus 300 as a document.

The document management software 340 analyzes the document (image of the document 390) and appends attributes to the document in accordance with the analysis results, and stores the document in one or both of the folders 325a and 325b in accordance with the appended attributes.

In response to an instruction to conduct a search from a user, the attribute search tool 335 searches the folders 325a and 325b for a document by using an attribute as a search key.

The folder 325 corresponds to the document storage module 125 of the information processing apparatus 100 and has functions as the attribute storage module 130.

The attribute search tool 335 corresponds to the search module 135 of the information processing apparatus 100.

The document management software 340 corresponds to the attribute (A) appending module 140 and the attribute (B) appending module 145 of the information processing apparatus 100.

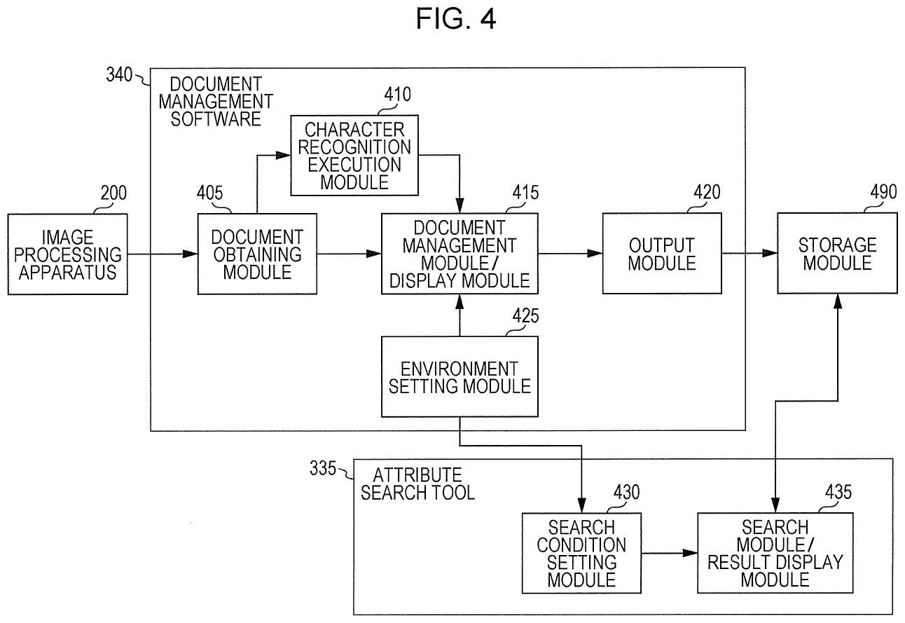

FIG. 4 is a block diagram illustrating the specific module configuration of the exemplary embodiment. More specifically, FIG. 4 illustrates examples of the detailed module configurations of the document management software 340 and the attribute search tool 335 shown in FIG. 3.

The document management software 340 includes a document obtaining module 405, a character recognition execution module 410, a document management module/display module 415, an output module 420, and an environment setting module 425. The attribute search tool 335 includes a search condition setting module 430 and a search module/result display module 435.

The image processing apparatus 200 is connected to the document obtaining module 405 of the document management software 340. The image processing apparatus 200 reads a document and sends the read document to the document obtaining module 405.

The document obtaining module 405 is connected to the image processing apparatus 200, the character recognition execution module 410, and the document management module/display module 415. The document obtaining module 405 obtains a document from the image processing apparatus 200 and provides it to the character recognition execution module 410 and the document management module/display module 415.

The character recognition execution module 410 is connected to the document obtaining module 405 and the document management module/display module 415. The character recognition execution module 410 executes character recognition processing on the document and provides text, which is the recognition result, to the document management module/display module 415. When executing character recognition processing, the character recognition execution module 410 analyzes the document and extracts the properties of characters and the positions of the characters, for example. The character recognition execution module 410 also executes language processing to extract statistical information concerning character strings and parts of speech of character strings, for example. The character recognition execution module 410 also extracts a character string having a predetermined positional relationship with a predetermined character string.

The document management module/display module 415 is connected to the document obtaining module 405, the character recognition execution module 410, the output module 420, and the environment setting module 425. The document management module/display module 415 associates information extracted by the character recognition execution module 410 with the document as attribute information. The document management module/display module 415 then displays the document and the attribute information so as to enable a user to correct the second attribute information.

The output module 420 is connected to the document management module/display module 415 and a storage module 490. The output module 420 outputs a document appended with attribute information by the document management module/display module 415 to the storage module 490. The storage module 490 stores the document.

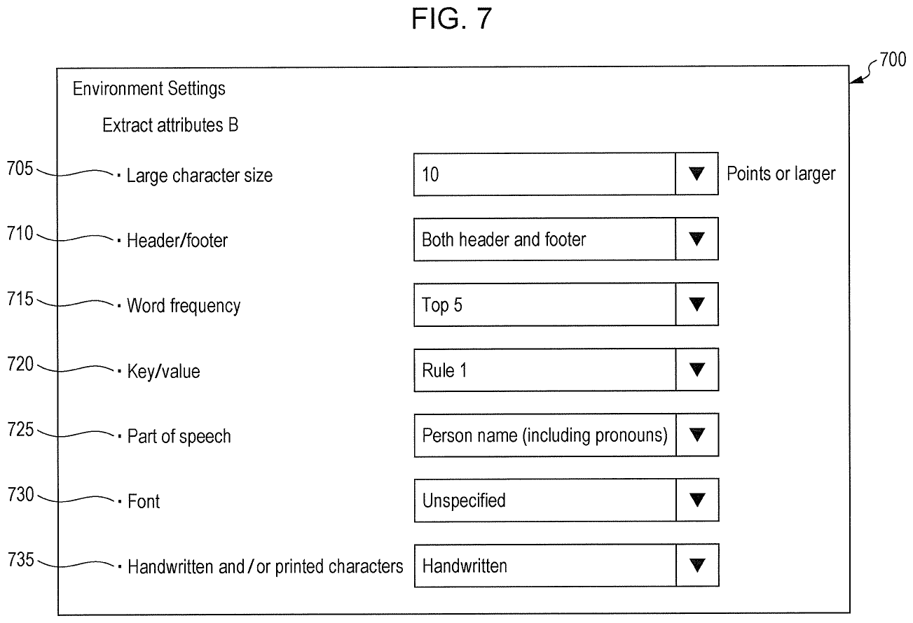

The environment setting module 425 is connected to the document management module/display module 415 and the search condition setting module 430 of the attribute search tool 335. The environment setting module 425 sets the conditions for obtaining attribute information as environment settings in accordance with an instruction from a user. Details of this setting operation will be discussed later by using an environment setting (attribute A extraction rules) screen 600 shown in FIG. 6A and an environment setting (attribute B extraction rules) screen 700 shown in FIG. 7.

The search condition setting module 430 is connected to the environment setting module 425 of the document management software 340 and the search module/result display module 435. The search condition setting module 430 receives environment settings from the environment setting module 425 and provides them to the search module/result display module 435 as search conditions.

The search module/result display module 435 is connected to the search condition setting module 430 and the storage module 490. In accordance with the environment settings received from the search condition setting module 430 and a search instruction from a user, the search module/result display module 435 searches the storage module 490 for a document having attribute information which matches the search conditions represented by the environment settings.

The storage module 490 is connected to the output module 420 of the document management software 340 and the search module/result display module 435 of the attribute search tool 335. The storage module 490 stores documents and items of attribute information appended to the documents. The storage module 490 corresponds to the folders 325a and 325b in FIG. 3.

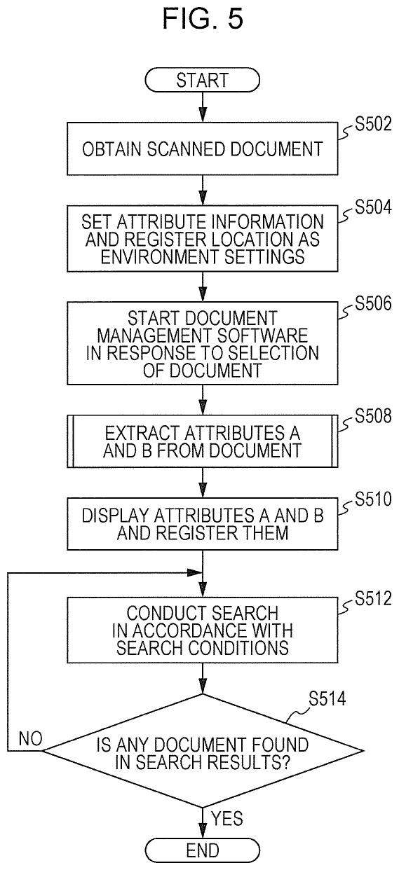

FIG. 5 is a flowchart illustrating an example of processing in the exemplary embodiment. More specifically, FIG. 5 illustrates an example of overall processing including registration of a document and attribute information and document searching.

In step S502, the information processing apparatus 300 obtains a document scanned by the image processing apparatus 200.

In step S504, attribute information and the register location are set as environment settings.

Steps S502 and S504 are operations executed in advance.

In step S506, when a document is selected, the document management software 340 is started.

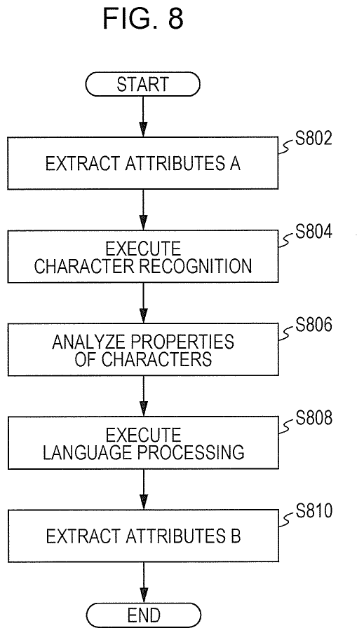

In step S508, attributes A and B are extracted from the document. Detailed processing of step S508 will be discussed later with reference to the flowchart in FIG. 8. To extract attributes B, in a case in which the document is an image, the character recognition result of the image is used, and in a case in which the document is a text document (including a document created by word-processing software), full text of the document is used.

In step S510, the attributes A and B are displayed so that a user can check and correct them. Then, the attributes A and B are registered. More specifically, the document is stored in a folder.

Steps S504 through S510 are executed by the document management software 340.

In step S512, search conditions are set in accordance with a user operation. Then, a search is conducted and the search results are displayed.

In step S514, it is judged whether any document is found in the search results. If a document is found, the processing is completed. If no document is found, the process returns to step S512.

Steps S512 and S514 are executed by the attribute search tool 335.

FIG. 6A illustrates a display example of the environment setting (attribute A extraction rules) screen 600.

The environment setting (attribute A extraction rules) screen 600 is displayed for enabling the environment setting module 425 to set rules for appending attributes A. Environments are set in response to a user operation.

As shown in the example in FIG. 6A, on the environment setting (attribute A extraction rules) screen 600, a document type list display region 605 and a property button 610, for example, are displayed.

In response to a user having clicked the property button 610 in the state in which a document type in the document type list display region 605 is selected, the editing screen for the selected document type is displayed. In the example in FIG. 6A, in response to the user having clicked the property button 610 in the state in which “receipt” is selected in the document type list display region 605, an editing screen 650 in FIG. 6B is displayed.

On the editing screen 650 for the receipt in the example in FIG. 6B, an attribute name field 655, a type field 660, a value field 665, an add button 670, and a list display region 675, for example, are displayed. In the list display region 675, regarding each attribute, the name, type, and value, information whether inputting of the attribute is required and whether editing is prohibited can be indicated. For example, if an attribute name which is not included in the list display region 675 (“123” in FIG. 6B) has been input in the attribute name field 655, the add button 670 is enabled. When the add button 670 is selected, the attribute name input in the attribute name field 655, the type input in the type field 660, and the value input in the value field 665 are reflected in the list display region 675.

As shown in FIG. 6C, in response to a user having selected an attribute in the list display region 675, a change button 680 is enabled. When the change button 680 is selected, the selected attribute is set with the attribute name in the attribute name field 655, the type in the type field 660, and the value in the value field 665.

FIG. 7 illustrates a display example of the environment setting (attribute B extraction rules) screen 700.

The environment setting (attribute B extraction rules) screen 700 is displayed for enabling the environment setting module 425 to set rules for appending attributes B. Environments are set in response to a user operation.

On the environment setting (attribute B extraction rules) screen 700, a large character size field 705, a header/footer field 710, a word frequency field 715, a key/value field 720, a part-of-speech field 725, a font field 730, and a handwritten/printed character field 735 are displayed.

In the large character size field 705, the rule for extracting characters written in a large size is set as an attribute B. Examples of characters in a large size to be extracted are “10 points or larger”, “the first and second largest sizes in document”. The size of characters is an example of the properties of characters. As another example of the properties of characters, the color of characters may be set.

In the header/footer field 710, the rule for extracting the header/the footer in a document is set as an attribute B. Examples of the rule are “both header and footer”, “header only”, “footer only”, and “neither”. The header/footer is an example of the positions of characters.

In the word frequency field 715, the rule for extracting words in terms of the number of times a word appears in a document is set as an attribute B. Examples of the rule are “top five” for selecting the top five words having the highest frequency of appearance in the document and “five times or more” for selecting words appearing in a document five times or more. The word frequency is an example of statistical information concerning character strings.

In the key/value field 720, the rule for extracting a character string having a predetermined positional relationship with a predetermined character string (hereinafter such extracting processing will also be called key/value processing) is set as an attribute B. An example of the rule is “rule 1”.

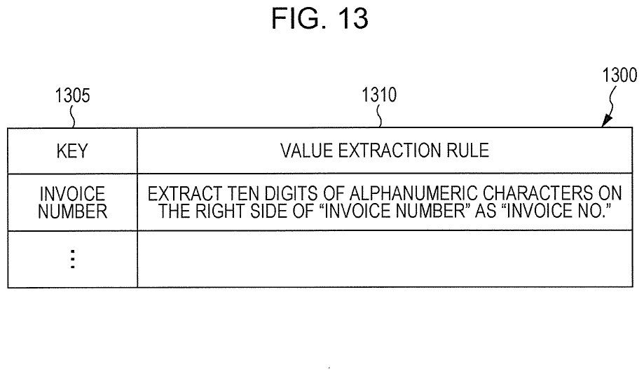

FIG. 13 illustrates an example of the data structure of a key/value extracting table 1300. More specifically, FIG. 13 illustrates an example of the rule for extracting a character string having a predetermined positional relationship with a predetermined character string.

The key/value extracting table 1300 has a key field 1305 and a value extraction rule field 1310. In the key field 1305, a key, which is a predetermined character string, is stored. In the value extraction rule field 1310, a value extraction rule is stored.

For example, as the rule 1, the first row of the key/value extracting table 1300 indicates that the value extraction rule for the key “Invoice number” is to extract ten digits of alphanumeric characters placed on the right side of the invoice number, as “Invoice No.”. With an option function of the image processing apparatus 200 or a certain function of the information processing apparatus 100, the attribute value is extracted in accordance with the key/value extracting table 1300. More specifically, with the option function of the image processing apparatus 200 or the certain function of the information processing apparatus 100, character recognition processing is performed on character images in the document, and if the characters in the key field 1305 are found in the character recognition result, the attribute value is extracted in accordance with the rule described in the value extraction rule field 1310. This makes it possible to extract a predetermined character string and a character string having a predetermined positional relationship with the predetermined character string.

In the part-of-speech field 725, the rule for extracting words in terms of the part of speech is set as an attribute B. Examples of the rule are “person names (including pronouns)”, “nouns”, and “addresses in Tokyo”. The result of determining the parts of speech of words (including words in the character recognition result) in a document by conducting morphological analysis, for example, is used to extract words in terms of the part of speech.

In the font field 730, the rule for extracting words in terms of the font is set as an attribute B. Examples of the font are “Minchotai” (a standard typeface in Japan), “Gothic”, and “OCR-B”. If no particular font is specified, “unspecified” is selected. The font is an example of the properties of characters.

In the handwritten/printed character field 735, the rule for extracting words in terms of whether a word is a handwritten or printed word is set as an attribute B. Examples of the rule are “handwritten”, “printed”, and “unspecified”. Handwritten/printed characters is an example of the properties of characters. If the rule is set as “unspecified”, both the handwritten words and printed words are selected.

FIG. 8 is a flowchart illustrating an example of processing in the exemplary embodiment. FIG. 8 illustrates an example of detailed processing in step S508 of FIG. 5.

In step S802, attributes A are extracted from a subject document. The attributes A are attributes that are already appended to the document and, for example, those provided with a flag indicating that they are attributes A.

In step S804, character recognition processing is executed on the document.

In step S806, the properties of characters are analyzed. As discussed above, the size, color, positions of characters, and whether the characters are handwritten or printed are determined.

In step S808, language processing, such as morphological analysis, is executed. More specifically, statistical information concerning character strings and the parts of speech of character strings are determined.

In step S810, attributes B are extracted. The attributes B are extracted in accordance with the rules set on the environment setting (attribute B extraction rules) screen 700 in FIG. 7. A character string is also extracted as an attribute B by executing key/value processing. A flag is added to the extracted attributes B to indicate that they are attributes B, and the attributes B are appended to the document.

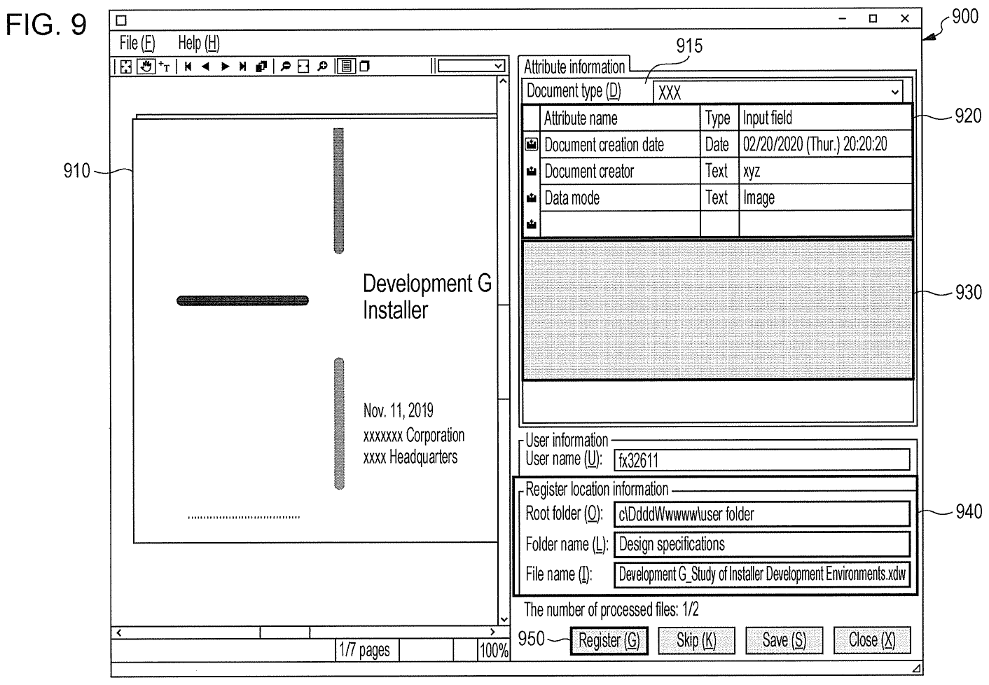

FIG. 9 illustrates an example of processing in the exemplary embodiment.

On a screen 900, a document display region 910, a document type display region 915, an attribute A display region 920, an attribute B display region 930, a register location display region 940, and a register button 950, for example, are displayed. The document management module/display module 415 displays the screen 900.

In the document display region 910, a subject document is displayed. This mode of display is also called preview display.

In the attribute A display region 920, the attributes A extracted in accordance with the rules set on the environment setting (attribute A extraction rules) screen 600 are displayed.

For example, in the attribute A display region 920, regarding the document type “XXX”, the first row indicates that the attribute name is “Document creation date”, the type is “Date”, and the input field is “02/20/2020 (Thur.) 20:20:20”. The second row indicates that the attribute name is “Document creator”, the type is “Text”, and the input field is “xyz”. The third row indicates that the attribute name is “Data mode”, the type is “Text”, and the input field is “Image”.

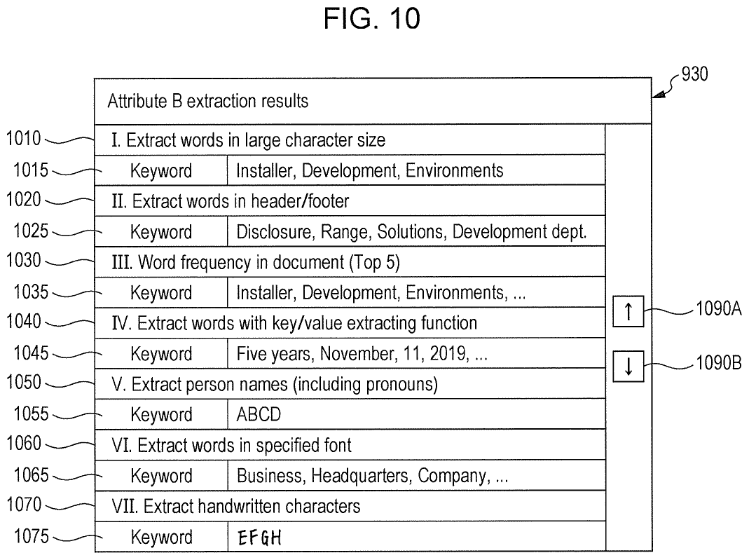

In the attribute B display region 930, the attributes B extracted in accordance with the rules set on the environment setting (attribute B extraction rules) screen 700 are displayed. Details of the attribute B display region 930 will be discussed later with reference to FIG. 10.

In the register location display region 940, information concerning the register location of the document is displayed. For example, as the register location information, the root folder “c\DdddWwwww\user folder”, the folder name “Design specifications”, and the file name “Development G_Study of Installer Development Environments.xdw”, are indicated in the register location display region 940.

In response to a user having clicked the register button 950, concerning the document type indicated in the document type display region 915, the attributes displayed in the attribute A display region 920 and the attribute B display region 930 on the screen 900 are appended to the document. Then, the document is stored in the register location displayed in the register location display region 940.

FIG. 10 illustrates a display example of the attribute B display region 930.

In the attribute B display region 930, an attribute B (large character size) field 1010, a keyword field 1015, an attribute B (header/footer) field 1020, a keyword field 1025, an attribute B (word frequency) field 1030, a keyword field 1035, an attribute B (key/value) field 1040, a keyword field 1045, an attribute B (parts of speech) field 1050, a keyword field 1055, an attribute B (font) field 1060, a keyword field 1065, an attribute B (handwritten/printed characters) field 1070, a keyword field 1075, a priority change (higher) button 1090A, and a priority change (lower) button 1090B are displayed. The keywords in the keyword fields 1015, 1025, 1035, 1045, 1055, 1065, and 1075 correspond to the results extracted in accordance with the rules set on the environment setting (attribute B extraction rules) screen 700.

In the attribute B (large character size) field 1010, the results of extracting words in a large size are displayed. More specifically, in the keyword field 1015, “Installer, Development, Environments” written in a large size are extracted as the keywords of this attribute B.

In the attribute B (header/footer) field 1020, the results of extracting words written in a header and/or a footer are displayed. More specifically, in the keyword field 1025, “Disclosure, Range, Solutions, Development dept.” written in the header or the footer are extracted as the keywords of this attribute B.

In the attribute B (word frequency) field 1030, the results of extracting the top five words having the highest frequency of appearance in the document are displayed. More specifically, in the keyword field 1035, “Installer, Development, Environments, . . . ” frequently appearing in the document are extracted as the keyword of this attribute B.

In the attribute B (key/value) field 1040, the results of extracting words as a result of executing key/value extracting processing are displayed. More specifically, in the keyword field 1045, the extraction results “Five years, Nov. 11, 2019, . . . ” are extracted as the keywords of this attribute B.

In the attribute B (parts of speech) field 1050, the results of extracting the person names are displayed. More specifically, in the keyword field 1055, the person name “ABCD” is extracted as the keyword of this attribute B.

In the attribute B (font) field 1060, the result of extracting words written in a specified font is displayed. More specifically, in the keyword field 1065, “Business, Headquarters, Company . . . ” written in a specified font are extracted as the keywords of this attribute B.

In the attribute B (handwritten/printed characters) field 1070, the results of extracting words with handwritten characters and/or printed characters are displayed. More specifically, in the keyword field 1075, “EFGH” with handwritten characters are extracted as the keyword of this attribute B.

With the priority change (higher) button 1090A and the priority change (lower) button 1090B, the priority ranks of attributes B to be used for a search can be changed. More specifically, after one of the attribute B (large character size) field 1010, the attribute B (header/footer) field 1020, the attribute B (word frequency) field 1030, the attribute B (key/value) field 1040, the attribute B (parts of speech) field 1050, the attribute B (font) field 1060, and the attribute B (handwritten/printed characters) field 1070 is selected, the priority change (higher) button 1090A or the priority change (lower) button 1090B is selected. Then, the selected field is moved to a higher position or a lower position in the attribute B display region 930. As a result, the priority ranks in the attribute B display region 930 are changed. That is, keywords located at higher positions in the attribute B display region 930 are more likely to be used for a search.

The rules for extracting attributes B are set on the environment setting (attribute B extraction rules) screen 700 shown in FIG. 7. Alternatively, the rules may be set in the attribute B (large character size) field 1010, the attribute B (header/footer) field 1020, the attribute B (word frequency) field 1030, the attribute B (key/value) field 1040, the attribute B (parts of speech) field 1050, the attribute B (font) field 1060, and the attribute B (handwritten/printed characters) field 1070. For example, in the attribute B (font) field 1060, a specific font, such as “Minchotai”, “Gothic”, or “OCR-B”, may be set.

The keywords in the keyword fields 1015, 1025, 1035, 1045, 1055, 1065, and 1075 may be changed in accordance with a user operation. The reason for this is that the keywords in keyword fields, such as in the keyword field 1015, are results of executing character recognition processing, and they may be wrongly recognized.

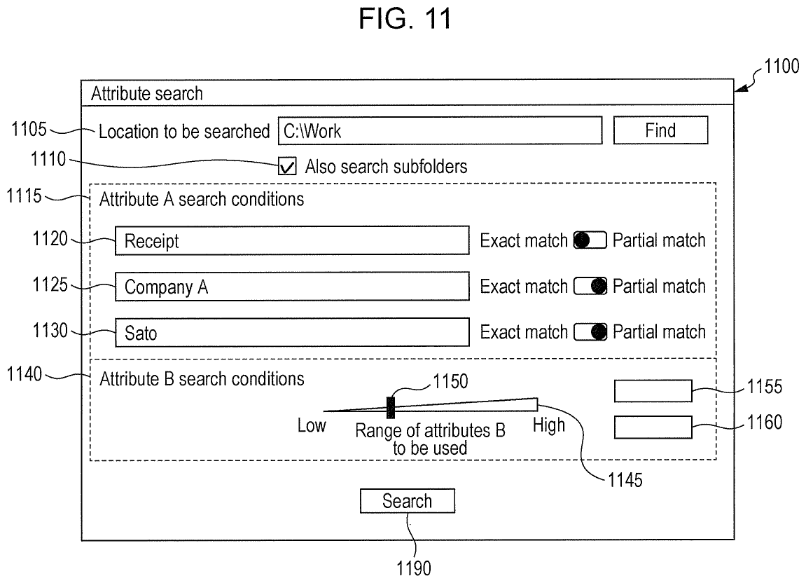

FIG. 11 illustrates a display example of an attribute search screen 1100.

The attribute search screen 1100 is a screen displayed by the search condition setting module 430 of the attribute search tool 335 and used for a user to give an instruction to conduct a search.

On the attribute search screen 1100, a search location field 1105, a check field 1110, an attribute A search condition field 1115, an attribute B search condition field 1140, and a search button 1190, for example, are displayed.

In the search location field 1105, the storage location of documents to be searched is specified. More specifically, a folder or a uniform resource locator (URL), for example, is specified. In the check field 1110, a user can check a checkbox to select whether to also search documents under subfolders in the storage location specified in the search location field 1105.

In the attribute A search condition field 1115, search term fields 1120, 1125, and 1130 for a user to specify search terms are displayed. For each search term, a user can select one of an exact match search and a partial match search to be conducted. In the search term fields 1120, 1125, and 1130, search terms to be used for a search using attribute information (attributes A) are input.

In the attribute B search condition field 1140, an attribute B range setting field 1145 and search term fields 1155 and 1160 are displayed. In the search term fields 1155 and 1160, search terms to be used for a search using attribute information (attributes B) are input.

By using a slider bar 1150 in the attribute B range setting field 1145, a user can determine which attributes B in the attribute B display region 930 will be used for searching for the terms in the search term fields 1155 and 1160. The user can make this determination by shifting the slider bar 1150 to the left and right sides. As the user shifts the slider bar 1150 farther toward the right side, the lower ranks of attributes B can be used for a search. If the user shifts the slider bar 1150 to the right-side edge of the attribute B range setting field 1145, all the attributes B specified in the attribute B display region 930, and more specifically, all the keywords in the keyword fields 1015, 1025, 1035, 1045, 1055, 1065, and 1075, are used for a search. If the user shifts the slider bar 1150 to the left-side edge of the attribute B range setting field 1145, the attribute B at the top rank in the attribute B display region 930, and more specifically, the keywords in the keyword field 1015, are used for a search. If the user places the slider bar 1150 at the center of the attribute B range setting field 1145, the attributes B from the top to the middle ranks in the attribute B display region 930, more specifically, the keywords in the keyword fields 1015, 1025, 1035, and 1045, are used for a search. In this manner, a user is able to specify higher ranks of attributes B to be used for a search.

In this example, for the attributes B, a partial match search is conducted exclusively. The reason for this is that the keywords of the attributes B may include wrongly recognized words, as stated above.

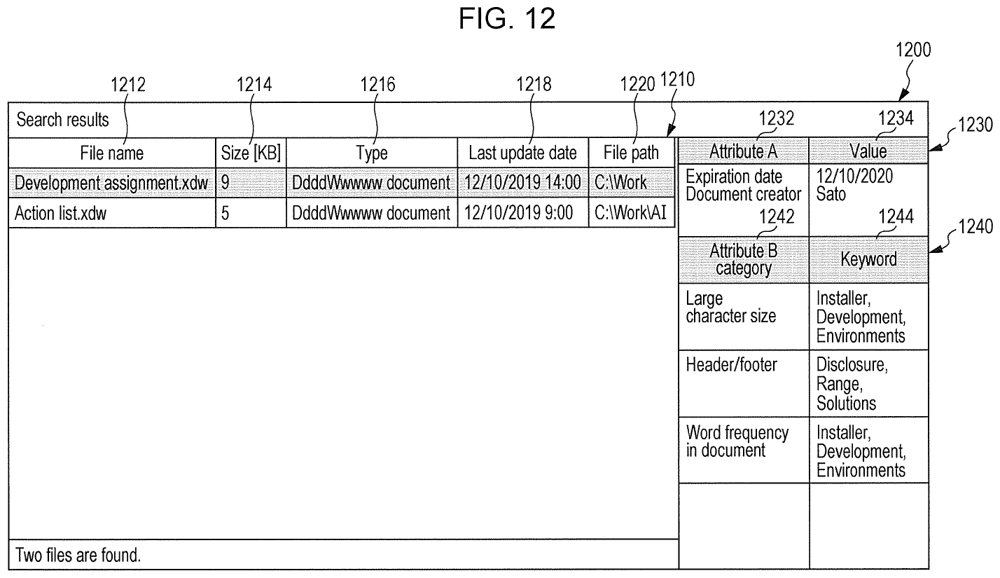

FIG. 12 illustrates a display example of a search result screen 1200.

The search result screen 1200, which is displayed by the search module/result display module 435 of the attribute search tool 335, indicates the result of conducting a search in accordance with the content of the attribute search screen 1100 shown in FIG. 11.

On the search result screen 1200, a search result table 1210, an attribute A information table 1230, and an attribute B information table 1240 are displayed.

The search result table 1210 displays documents found as the search results in a list form. The search result table 1210 has a file name field 1212, a size field 1214, a type field 1216, a last update date field 1218, and a file path field 1220. In the file name field 1212, the file name of a document is displayed. In the size field 1214, the size of this document is displayed. In the type field 1216, the file type of this document is displayed. In the last update date field 1218, the last update date of the document is displayed. In the file path field 1220, the storage location of the document is displayed.

In the search result table 1210, information concerning each document is displayed in one row. Information concerning the first document in the search results is described in the first row, for example. More specifically, in the first row, the file name field 1212 indicates “Development assignment.xdw”, the size field 1214 indicates “9 KB”, the type field 1216 indicates “DdddWwwww document”, the last update date field 1218 indicates “12/10/2019 14:00”, and the file path field 1220 indicates “C:\Work”. Information concerning the second document in the search results is described in the second row, for example. More specifically, the file name field 1212 indicates “Action list.xdw”, the size field 1214 indicates “5 KB”, the type field 1216 indicates “DdddWwwww document”, the last update date field 1218 indicates “12/10/2019 9:00”, and the file path field 1220 indicates “C:\Work\AI”.

In the attribute A information table 1230, information concerning the attributes A of the document selected by a user in the search result table 1210 is displayed.

The attribute A information table 1230 includes an attribute A field 1232 and a value field 1234. In the attribute A field 1232, the attributes A are displayed, and in the value field 1234, the values of these attributes A are displayed.

For example, in the first row of the attribute A information table 1230, “expiration date”, which is an attribute A, is indicated in the attribute A field 1232, and the value of this attribute A “12/10/2020” is indicated in the value field 1234. In the second row, “document creator”, which is another attribute A, is indicated in the attribute A field 1232, and the value of this attribute A “Sato” is indicated in the value field 1234.

In the attribute B information table 1240, information concerning the attributes B of the document selected by a user in the search result table 1210 is displayed.

The attribute B information table 1240 includes an attribute B category field 1242 and a keyword field 1244. In the attribute B category field 1242, the category (type) of the attribute B is displayed, and in the keyword field 1244, the keywords of the category are displayed.

For example, in the first row of the attribute B information table 1240, the attribute B “Large character size” is indicated in the attribute B category field 1242, and words that are found to be written in a large character size “Installer, Development, Environments” are indicated in the keyword field 1244. In the second row, the attribute B “Header/footer” is indicated in the attribute B category field 1242, and words written in the header/footer “Disclosure, Range, Solutions, Development dept.” are indicated in the keyword field 1244. In the third row, the attribute B “Word frequency in document” is indicated in the attribute B category field 1242, and the top five words having the highest frequency of appearance in the document “Installer, Development, Environments, . . . ” are indicated in the keyword field 1244.

The above-described program may be stored in a recording medium and be provided. The program recorded on a recording medium may be provided via a communication medium. In this case, the above-described program may be implemented as a “non-transitory computer readable medium storing the program therein” in the exemplary embodiment.

The “non-transitory computer readable medium storing a program therein” is a recording medium storing a program therein that can be read by a computer, and is used for installing, executing, and distributing the program.

Examples of the recording medium are digital versatile disks (DVDs), and more specifically, DVDs standardized by the DVD Forum, such as DVD-R, DVD-RW, and DVD-RAM, DVDs standardized by the DVD+RW Alliance, such as DVD+R and DVD+RW, compact discs (CDs), and more specifically, a CD read only memory (CD-ROM), a CD recordable (CD-R), and a CD rewritable (CD-RW), Blu-ray (registered trademark) disc, a magneto-optical disk (MO), a flexible disk (FD), magnetic tape, a hard disk, a ROM, an electrically erasable programmable read only memory (EEPROM) (registered trademark), a flash memory, a RAM, a secure digital (SD) memory card, etc.

The entirety or part of the above-described program may be recorded on such a recording medium and stored therein or distributed. Alternatively, the entirety or part of the program may be transmitted through communication by using a transmission medium, such as a wired network used for a local area network (LAN), a metropolitan area network (MAN), a wide area network (WAN), the Internet, an intranet, or an extranet, a wireless communication network, or a combination of such networks. The program may be transmitted by using carrier waves.

The above-described program may be the entirety or part of another program, or may be recorded, together with another program, on a recording medium. The program may be divided and recorded on plural recording media. The program may be recorded in any form, for example, it may be compressed or encrypted, as long as it can be reconstructed.

In the embodiment above, the term “processor” refers to hardware in a broad sense. Examples of the processor includes general processors (e.g., CPU: Central Processing Unit), dedicated processors (e.g., GPU: Graphics Processing Unit, ASIC: Application Integrated Circuit, FPGA: Field Programmable Gate Array, and programmable logic device).

In the embodiment above, the term “processor” is broad enough to encompass one processor or plural processors in collaboration which are located physically apart from each other but may work cooperatively. The order of operations of the processor is not limited to one described in the embodiment above, and may be changed.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to
perform a document search by using data stored in a memory, the data including attribute information indicating attributes appended to each document, the attributes including a user-appended attribute and a software-extracted attribute extracted by document management software,
wherein the user-appended attribute and the software-extracted attribute are configured to be distinguishable from each other.

2. An information processing apparatus of according to claim 1,
wherein the data includes information indicating each of the attributes is a user-appended attribute or a software-extracted attribute.

3. The information processing apparatus according to claim 1, wherein:
the attribute includes a plurality of software-extracted attributes extracted by the document management software; and
the processor is configured to:
perform the document search in accordance with priority settings of the plurality of software-extracted attributes.

4. The information processing apparatus according to claim 2, wherein:
the attribute includes a plurality of software-extracted attributes extracted by the document management software; and
the processor is configured to:
conduct the document search in accordance with priority settings of the plurality of software-extracted attributes.

5. The information processing apparatus according to claim 3, wherein:
the document is an image;
the plurality of software-extracted attributes include attributes extracted by performing image analysis; and
the plurality of software-extracted attributes include at least one of:
(a) property of text,
(b) position of text,
(c) statistics on text,
(d) part of speech information obtained from text; and
(e) a character string having a predetermined positional relationship with a predetermined character string.

6. The information processing apparatus according to claim 4, wherein:
the document is an image;
the plurality of software-extracted attributes include attributes extracted by performing image analysis on the image; and
the plurality of software-extracted attributes include at least one of:
(a) property of text,
(b) position of text,
(c) statistics on text,
(d) part of speech information obtained from text; and
(e) a character string having a predetermined positional relationship with a predetermined character string.

7. The information processing apparatus according to claim 5,
wherein the processor is configured to receive a user instruction specifying the settings of the plurality of software-extracted attributes.

8. The information processing apparatus according to claim 3,
wherein the processor is configured to receive a user instruction specifying the settings of the plurality of software-extracted attributes.

9. The information processing apparatus according to claim 4,
wherein the processor is configured to receive a user instruction specifying the settings of the plurality of software-extracted attributes.

10. The information processing apparatus according to claim 6,
wherein the processor is configured to receive a user instruction specifying the settings of the plurality of software-extracted attributes.

11. The information processing apparatus according to claim 7,
wherein the processor is configured to receive a user instruction specifying the settings of the plurality of software-extracted attributes.

12. The information processing apparatus according to claim 1, wherein the processor is configured to:
receive a user instruction that specifies a setting of the document search, wherein the setting of the document search includes whether to apply an exact match or a partial match for the user-appended attribute; and
conduct the document search in accordance with the settings.

13. The information processing apparatus according to claim 2, wherein the processor is configured to:
receive a user instruction that specifies a setting of the document search, wherein the setting of the document search includes whether to apply an exact match or a partial match for the user-appended attribute; and
conduct the document search in accordance with the settings.

14. The information processing apparatus according to claim 12, wherein a partial match is automatically applied to the software-extracted attribute.

15. The information processing apparatus according to claim 13, wherein a partial match is automatically applied to the software-extracted attribute.

16. A non-transitory computer readable medium storing a program causing a computer to execute a process, the process comprising:
conducting a document search by using data stored in a memory, the data including attribute information indicating attributes appended to each document, the attributes including a user-appended attribute and a software-extracted attribute extracted by document management software, wherein the user-appended attribute and the software-extracted attribute are configured to be distinguishable from each other.

17. An information processing apparatus comprising:
means for storing data; and
means for conducting a document search by using data stored in the means for storing data, the data including attribute information indicating attributes appended to each document, the attributes including a user-appended attribute and a software-extracted attribute extracted by document management software,
wherein the user-appended attribute and the software-extracted attribute are configured to be distinguishable from each other.
